(19) United States
(12) Patent Application Publication
(10) Pub. No.: US 2008/0017199 A1
(43) Pub. Date: Jan. 24, 2008

(54) Regulation For Use In Cold Water

(76) Inventor: Nino Pietrelli, Sori (IT)

Correspondence Address: STITES & HARBISON PLLC, 1199 NORTH FAIRFAX STREET, SUITE 900, ALEXANDRIA, VA, 22314, US

(21) Appl. No.: 11/570,381

(22) PCT Filed: Dec. 3, 2004
(86) PCT No.: PCT/EP04/53271

§ 371 Date: Dec. 11, 2006

(30) Foreign Application Priority Data
Jul. 2, 2004 (IT) GE2004A000058

(51) Int. Cl. B63C 11/22; A62B 9/00

(52) U.S. Cl. 128/205.24

(57) ABSTRACT

Regulator for underwater breathing apparatus of the type comprising a box-shaped body provided with a pressure-controlled membrane which divides the inside of the body into a first chamber communicating with the atmosphere and a second chamber communicating with a compressed-air inlet valve operated by a lever cooperating with said pressure-controlled membrane and also provided with an air discharge valve and a tube equipped with mouthpiece, characterized in that the box-shaped body of said regulator is made at least partially of thermally conductive polymers. Advantageously, said thermally conductive polymers used consist of engineering polymers having a matrix of polyamide, polycarbonate or PET (polyethylene terephthalate) or TPU (thermoplastic polyurethane) or the like containing metallic or graphite fibre or carbon fibre fillers dispersed within the polymer matrix.

### DESCRIPTION

The present invention relates to regulators for scuba diving breathing apparatus and, in particular although not necessarily, to regulators to be used in cold water.

The main drawback which is encountered in regulators operating in cold water—this expression being understood as referring to water at a temperature of a few degrees above zero—consists in the fact that, owing to the expansion of the compressed air supplied into the chamber of the regulator with each breath via the inlet valve, opening of which is actuated by a lever associated with the pressure-controlled membrane of the regulator, a drop in temperature to below zero occurs in the vicinity of this lever, such that the water vapour present in the chamber of the regulator tends to be converted into ice with the risk of impeding or interfering with correct operation of the lever operating the air inlet valve.

At present, the body of the regulators is made either of metal or plastic or plastic with metal parts incorporated or inserted therein so as to provide the plastic body with a certain heat-conducting capacity.

The regulators with a completely metallic body are not affected at all, or only to a limited degree, by the abovementioned problem since the relatively large metallic mass of their body absorbs and distributes easily these small drops in temperature caused by the said expansion of air in the region of the inlet valve. However, these regulators are costly, are relatively heavy and in particular are not very flexible with regard to the shaping thereof during the forming step.

Regulators with all-plastic bodies, generally made of engineering polymers such as polyamides, acetal resins or polycarbonates which may or may not be reinforced with glass fibres or glass globules, possess a high degree of flexibility, namely during moulding, may be moulded easily, but are heat-insulating, which is a major disadvantage from the point of view of solution of the abovementioned problem.

Regulators with a plastic body and metal inserts, such as those forming the subject of European Patent No. EP 0 742 031 B1 in the name of the same Applicant, partly overcome the disadvantages of both metal regulators and plastic regulators, resulting in a fairly acceptable compromise, although they have an excessively high manufacturing cost.

Finally, French Patent No. 2 644 750 and European Patent No. 0 512 887 B1, both in the name of Spirotechnique Industrielle et Commerciale, in order to overcome said drawback, have proposed mounting the lever co-operating with the pressure-controlled membrane of the regulator at a distance from the valve for introducing the compressed air into the chamber of the regulator. For this purpose, according to said patents, the rod operating the obturator of the air inlet valve, associated with the lever co-operating with the pressure-controlled membrane, has been extended inside the body of the regulator as far as the end of this body diametrically opposite to that where the compressed-air supply valve emerges. Moreover, the patent EP 0 512 887 B1 proposed manufacturing the tubular element containing the expansion valve from metal, providing it with radial fins in order to increase the heat exchange area thereof.

However, this system has also proved to be costly and not very efficient.

According to the present invention, it was thought to overcome the disadvantages and difficulties of the prior art by manufacturing the bodies of these regulators at least partly from thermally conductive polymers, such as the new engineering polymers with a matrix of polyamide, or polycarbonate or PET (polyethylene terephthalate) or TPU (thermoplastic polyurethane) or the like containing fillers composed of metal particles or graphite fibres or carbon fibres dispersed within the polymer matrix using novel technology often patented by the various manufacturers and able to convert the polymer into a good heat conductor.

The conductivity values of these thermoplastic materials with special fillers are often superior to those of certain materials and for example superior to that of stainless steel and, even where reinforced with conventional fillers, have conductivity values up to 10-15 times greater than those of the original polymer.

Some trade names of these highly conductive polymers are Latiohm (carbon-fibre-reinforced engineering polymer) produced by LATI; Konduit (engineering polymer reinforced with metal fillers) produced by LNP; Thermal Graph (engineering polymer reinforced with graphite fillers) produced by BP AMOCO, and Krailon (graphite-reinforced engineering polymer) produced by COBRAPLAST.

By using these conductive polymers for manufacture of the body of the regulators for underwater breathing apparatus, the advantage of maximum flexibility, lightness and ease of moulding of the plastic bodies is obtained, together with the advantages of the high thermal conductivity characteristic of metallic bodies.

Obviously, the body of the regulator may advantageously be provided with radial fins for even greater dissipation of the heat by said body, something which is difficult to achieve in the bodies of metal regulators or plastic regulators with metal inserts.

1. Regulator for underwater breathing apparatus of the type comprising a box-shaped body provided with a pressure-controlled membrane which divides the inside of the body into a first chamber communicating with the atmosphere and a second chamber communicating with a compressed-air inlet valve operated by a lever co-operating with said pressure-controlled membrane and also provided with an air discharge valve and a tube equipped with mouthpiece, characterized in that the box-shaped body of said regulator is made at least partly of thermally conductive polymers.

2. Regulator according to claim 1, in which said thermally conductive polymers used consist of engineering polymers with a matrix of polyamide or polycarbonate or PET (polyethylene terephthalate) or TPU (thermoplastic polyurethane) or the like containing metal particle or graphite fibre or carbon fibre fillers dispersed within the polymer matrix.

3. Regulator according to claim 2, characterized in that said thermoplastic materials with special fillers have conductivity values which are 5 to 15 times greater than those of the basic polymer matrix.

4. Regulator according to claim 2 characterized in that engineering polymers reinforced with carbon fibres or engineering polymers reinforced with metal fillers or engineering polymers reinforced with graphite fillers or mixtures of these polymers are preferably used as conductive engineering polymers.

5. Regulator according to claim 4, in which said engineering polymers used are those which are known by the trade names of Latiohm produced by LATI, Konduit produced by LNP; Thermal Graph produced by BP AMOCO; and Krailon produced by COBRAPLAST.

6. Regulator for underwater breathing apparatus having a body made at least partly of conductive engineering polymers, substantially as claimed in claim 5 above.
